(19) United States
(12) Patent Application Publication
(10) Pub. No.: US 2007/0054659 A1
(43) Pub. Date: Mar. 8, 2007

(54) Multimode communication device having an automatic call-back setting mechanism and its method

(75) Inventors: Yi-Hsiung Chou, Shengang Township (TW); Jui-Hsiang Liu, Gangshan Township (TW); Wen-Chi Chen, Hsinchu City (TW)

Correspondence Address: TROXELL LAW OFFICE PLLC;ONE SKYLINE PLACE, SUITE 1404, 5205 LESSBURG PIKE, FALLS CHURCH, VA, 22041, US

(73) Assignee: Sunplus Technology Co., Ltd.

(21) Appl. No.: 11/266,293

(22) Filed: Nov. 4, 2005

(30) Foreign Application Priority Data
Sep. 5, 2005 (TW) 094130259

(51) Int. Cl. H04M 3/42

(52) U.S. Cl. 455/417

(57) ABSTRACT

The present invention relates to a multimode communication device having an automatic call-back setting mechanism that includes a first wireless communication module for transmitting a first radio frequency signal and having a decision process; a second wireless communication module coupled to the first wireless communication module for transmitting a second radio frequency signal. If the first wireless communication module receives an incoming call signal of a communication system, the determination process will determine whether or not to terminate the incoming call signal and the second wireless communication module makes a call back to the communication system. The invention also discloses a method for automatically setting the call-back mechanism and a method for setting a man-machine interface for automatically setting a call-back mechanism.

### BACKGROUND OF THE INVENTION

1. Field of the Invention

The present invention relates to a multimode communication device having an automatic call-back setting mechanism and its method, and more particularly to a multimode communication device having an automatic call-back setting mechanism and its method that a user can set an automatic call-back mechanism. If a mobile phone user receives an incoming call from a wireless communication system, the call will be determined whether or not the conditions set by the user are satisfied, and the call will be hung up automatically, and an automatic call back to the wireless communication system will be made according to the user's settings, so as to save telephone fee.

2. Description of the Related Art

Common personal wireless communication systems include Global System for Mobile Communication (GSM), General Packet Radio Service (GPRS), Enhanced Data Rate for GSM Evolution (EDGE), Personal Handyphone System (PHS), Code Division Multiple Access (CDMA), and Wideband Code Division Multiple Access (WCDMA), etc. In general, it is necessary to pay a fee for receiving a telephone and to support two or more kind of the mobile phone wireless communication systems (such as the foregoing GSM, GPRS, PHS, CDMA, WCDMA). If a mobile phone user receives a phone call from the mobile phone wireless communication system with a higher rate of telephone fees (such as the GSM system), the mobile phone user usually refuses the incoming call because of the higher telephone fees, and then manually dials the caller from a mobile phone wireless communication system with a lower rate of telephone fees (such as the PHS system). Such process not only causes a troublesome process, but also wastes the user's time to manually select a telephone system that charges a lower rate of telephone fees and dial the call.

U.S. Pat. No. 6,445,921 entitled “Call re-establishment for a dual mode telephone” (filed on Dec. 20, 1999 and issued on Sep. 3, 2002) discloses a wireless communication device for establishing communication with a remote terminal device through a cordless or a mobile base station and a method for establishing communication between a wireless communication device and a remote terminal device. However, such patent discloses a dual mode communication device having the communication functions of a mobile phone and a wireless telephone, and the wireless telephone communication could be a Digital European Cordless Telephone System (DECT), a FM wireless phone system, a spread spectrum wireless telephone system or a Bluetooth wireless telephone system, etc, and the mobile phone could be the aforementioned GSM, PHS, CDMA, or AMPS phone, and the dual mode communication device of that patent could establish a call connection between a wireless phone communication and the mobile phone communication for a user to select a cheaper rate of telephone fees.

However, the dual mode communication device of the foregoing patent provides a call connection between the wireless telephone communication and the mobile phone communication, and the dual mode communication device is not a dual mode mobile phone communication. In other words, when a user receives an incoming call from a mobile phone wireless communication system with a higher rate of telephone fees (such as the GSM system), the dual mode communication device cannot call the caller back from another mobile phone communication system with a lower rate of telephone fees (such as the PHS system). Furthermore, the communication distance of the DECT, FM wireless phone system, spread spectrum wireless phone system, or Bluetooth wireless phone system is much inferior to the mobile phone communication system.

R.O.C. Pat. No. 242952 entitled “Mobile communication device having a restricted call-back function” (filed on Aug. 15, 2003 and issued on Sep. 1, 2004) discloses a mobile communication device having a restricted call-back function for restricting to call back a telephone number of an incoming call signal, but such mobile phone communication device stores at least one restricted number in the memory, so that when an incoming call signal is received, its comparison module compares whether or not the telephone number of the incoming call signal is the same as the restricted number stored in the memory. If these two telephone numbers are the same, then no call-back phone call will be made. If the telephone numbers are not the same, then a call-back phone call will be made. Therefore, this patent does not disclose the dual mode function and basically has not taken the mobile phone communication fee into consideration.

In view of the shortcomings of the prior arts, we need a multimode communication device having an automatic call-back setting mechanism that can support two or more mobile phone wireless communication systems and its method, so that when a user receives an incoming call signal at a dual mode mobile phone, the dual mode mobile phone automatically selects the wireless communication system with a lower telephone rate of communication fees, so as to save telephone fees and overcome the foregoing shortcomings of the prior arts.

### SUMMARY OF THE INVENTION

Therefore, it is a primary objective of the present invention to provide a multimode communication device having an automatic call-back setting mechanism that allows users to set an automatic call-back setting mechanism. If a mobile phone user receives an incoming call from a wireless communication system, the multimode communication device of the invention will determine whether or not the conditions set by the user is met to automatically hang up the phone and use the user's set call-back wireless communication system to automatically call the caller back in order to save telephone fees.

Another objective of the present invention is to provide a method for automatically setting a call-back phone call used in a multimode communication device that allows users to set an automatic call-back mechanism. If a mobile phone user receives an incoming call from a wireless communication system, the multimode communication device of the invention will determine whether or not the conditions set by the user are met to automatically hang up the phone and use the user's set call-back wireless communication system to automatically call the caller back in order to save telephone fees.

A further objective of the present invention is to provide a method of setting a man-machine operating interface of an automatic call-back setting mechanism that allows users to set a call-back wireless communication system to automatically call the caller back in order to save telephone fees.

To achieve the foregoing objectives, the multimode communication device having an automatic call-back setting mechanism in accordance with the present invention comprises: a first wireless communication module for transmitting a first radio frequency signal, and including a determination process; and a second wireless communication module coupled to the first wireless communication module for transmitting a second radio frequency signal; thereby if the first wireless communication module receives an incoming call signal from a communication system, the determination process will determine whether or not to terminate the incoming call signal and call the communication system back from the second wireless communication module.

To achieve the foregoing objectives, the method for automatically setting a call-back phone call used in a multimode communication device, and the multimode communication device comprises a first wireless communication module and a second wireless communication module and the method comprises the steps of: determining whether or not the first wireless communication module turns on a call-back communication mechanism, and if no, then the first communication module will ring normally; determining whether or not the incoming call signal of a communication system includes an incoming call number (Caller ID), and if no, then the first wireless communication module will ring normally; determining whether or not the incoming call signal comes from a set automatic call-back communication system, and if yes, then the first wireless communication module will ring normally; checking a signal and a condition of the second wireless communication module; determining whether or not the signal and condition of the second wireless communication module are good, and if no, then the first wireless communication module will ring normally; turning on the automatic call-back ring of the first wireless communication module; determining whether or not a user receives an incoming call during the period when the automatic call-back ring is turned on, and if yes, then the first wireless communication module normally receives the incoming call signal; hanging up the incoming call signal of the set automatic call-back communication system; and dialing a call from the second wireless communication module and waiting for the receipt of an opposite party.

To achieve the foregoing objectives, a method of setting a man-machine operating interface of an automatic call-back setting mechanism, capable of being executed in a multimode communication device, and the multimode communication device comprises a first wireless communication module and a second wireless communication module, and the method of setting the man-machine interface comprises the steps of: turning on the multimode communication device; the multimode communication device entering into a standby status; entering into an automatic call-back setting mechanism functional menu; determining whether or not to select a processing function, and if no, then return to the standby status; determining whether or not to turn on the automatic call-back setting mechanism, and if no, then stop the processing function; the multimode communication module lists the options supported by the communication system; a user selects the options of the automatic call-back setting mechanism; completing the process of turning on of the automatic call-back setting function; and the multimode communication device automatically returning to the automatic call-back setting mechanism functional menu.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic block diagram of a multimode communication device having an automatic call-back setting mechanism according to a preferred embodiment of the present invention;

FIG. 2 is a flow chart of a method of automatically setting a call-back mechanism according to a preferred embodiment of the present invention; and

FIG. 3 is a flow chart of a man-machine operating interface automatically setting a call-back mechanism according to the present invention.

### DETAILED DESCRIPTION OF THE PREFERRED EMBODIMENTS

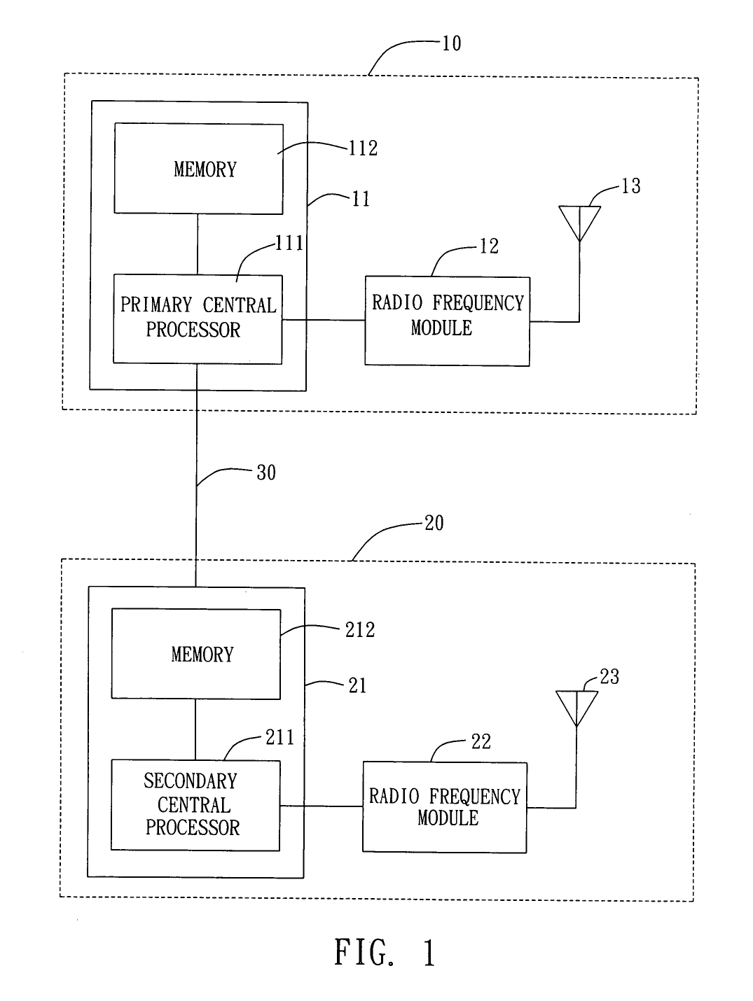

Referring to FIG. 1 for the schematic block diagram of a multimode communication device having an automatic call-back setting mechanism according to a preferred embodiment of the present invention, the multimode communication device having an automatic call-back setting mechanism comprises a first wireless communication module 10 and a second wireless communication module 20.

The first wireless communication module 10 is used for transmitting a first radio frequency signal and further comprises a determination process (not shown in the figure) and the first wireless communication module 10 includes but not limited to a GSM communication module.

Referring to FIG. 1, the first wireless communication module 10 further comprises a baseband module 11, a radio frequency module 12, and an antenna 13. The baseband module 11 is provided for transmitting a baseband signal, and the radio frequency module 12 is coupled to the baseband module 11 for converting the baseband signal into the first radio frequency signal including but not limited to a GSM radio frequency signal, and the antenna 13 is coupled to the radio frequency module 12 for transmitting or receiving the first radio frequency signal.

The baseband module 11 further comprises a primary central processor 111 and a memory 113. The primary central processor 111 is the core of the first wireless communication module 10 for executing the determination process to determine whether or not to call back automatically, and the memory 112 including but not limited to a flash memory is coupled to the primary central processor 111 for storing the determination process and temporarily saving data.

The second wireless communication module 20 is coupled to the first wireless communication module 10 through a streaming interface 30 including but not limited to a serial interface for transmitting a second radio frequency signal, wherein the second wireless communication device 20 includes but not limited to a PHS communication module and the second radio frequency signal includes but not limited to a PHS radio frequency signal.

Referring to FIG. 1, the second wireless communication module 20 further comprises a baseband module 21, a radio frequency module 22, and an antenna 23. The baseband module 21 is provided for transmitting a baseband signal, and the radio frequency module 22 is coupled to the baseband module 21 for converting the baseband signal into the second radio frequency signal including but not limited to a PHS radio frequency signal, and the antenna 23 is coupled to the radio frequency module 22 for transmitting or receiving the second radio frequency signal.

The baseband module 21 further comprises a secondary central processor 211 and a memory 212. The secondary central processor 211 is provided for assisting the primary central processor 111 to execute the determination process, and the memory 22 includes but not limited to a flash memory coupled to the secondary central processor 211 for temporarily saving data.

The determination process is stored in the memory and executed by the primary central processor 111 for determining whether or not to execute the automatic call-back process by the second wireless communication module 20. The determination process comprises the steps of: determining whether or not the first wireless communication module 10 turns on a call-back communication mechanism, and if no, then the first communication module 10 will ring normally; determining whether or not the incoming call signal of a communication system includes an incoming call number (Caller ID), and if no, then said first wireless communication module 10 will ring normally; determining whether or not the incoming call signal comes from a set automatic call-back communication system, and if yes, then the first wireless communication module 10 will ring normally; checking a signal and a condition of the second wireless communication module 20; determining whether or not the signal and condition of the second wireless communication module 20 are good, and if no, then the first wireless communication module 10 will ring normally; turning on the automatic call-back ring of the first wireless communication module 10; determining whether or not a user receives an incoming call during the period when the automatic call-back ring is turned on, and if yes, then the first wireless communication module 10 normally receives the incoming call signal; hanging up the incoming call signal of the set automatic call-back communication system; and dialing a call from the second wireless communication module 20 and waiting for the receipt of an opposite party.

The call-back communication mechanism is turned on or off by a man-machine operating interface (not shown in the figure) controlled by the first wireless communication module 10. The signal and condition of the call-back communication system refers to the signal intensity of the second wireless communication module 20.

If a mobile phone user receives an incoming call from a wireless communication system which is not set by the user, the first wireless communication module 10 (such as a GMS system) can determine whether or not the condition meets the user's setting according to the aforementioned determination process to automatically hang up the phone and use the user's set call-back second wireless communication system (such as a PHS system) to make a call-back phone call, so as to save telephone fees and overcome the shortcomings of the prior arts.

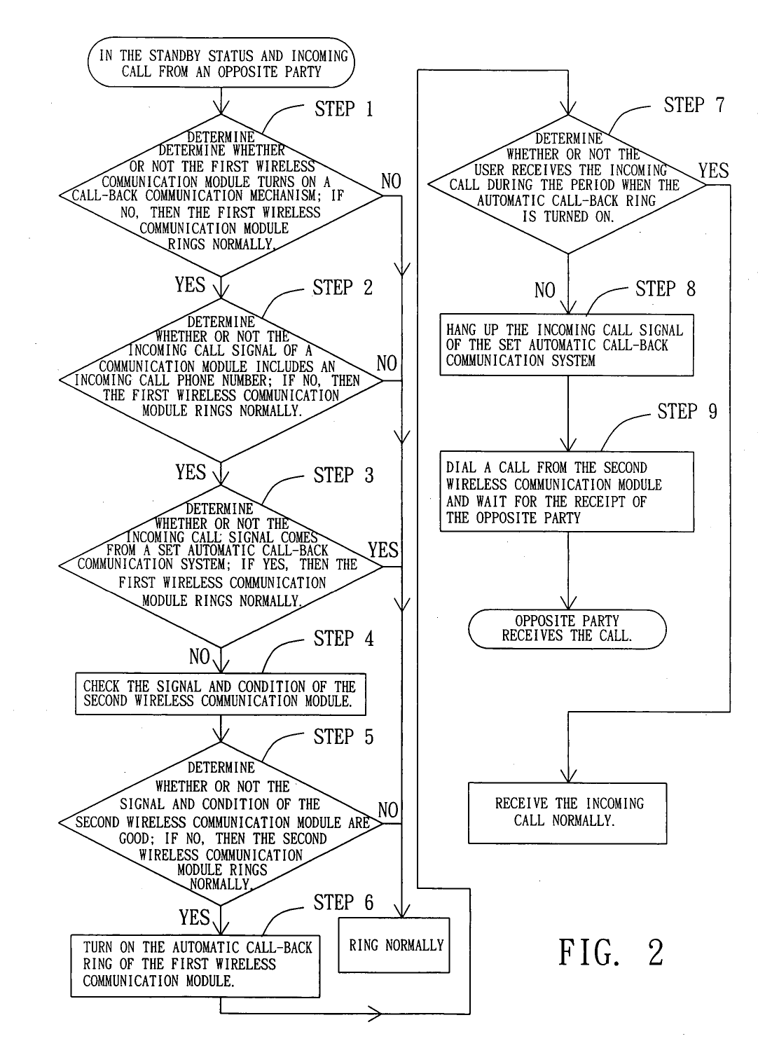

Refer to FIG. 2 for the flow chart of a method of automatically setting a call-back mechanism according to a preferred embodiment of the present invention. In the method of automatically setting a call-back phone call used in a multimode communication device, the multimode communication device comprises a first wireless communication module 10 and a second wireless communication module 10, and the method comprising the steps of: determining whether or not the first wireless communication module 10 turns on a call-back communication mechanism, and if no, then the first communication module 10 will ring normally (Step 1); determining whether or not the incoming call signal of a communication system includes an incoming call number (Caller ID), and if no, then the first wireless communication module 10 will ring normally (Step 2); determining whether or not the incoming call signal comes from a set automatic call-back communication system, and if yes, then the first wireless communication module 10 will ring normally (Step 3); checking a signal and a condition of the second wireless communication module 20 (Step 4); determining whether or not the signal and condition of the second wireless communication module 20 are good, and if no, then the first wireless communication module 10 will ring normally (Step 5); turning on the automatic call-back ring of the first wireless communication module 10 (Step 6); determining whether or not a user receives an incoming call during the period when the automatic call-back ring is turned on, and if yes, then the first wireless communication module 10 normally receives the incoming call signal (Step 7); hanging up the incoming call signal of the set automatic call-back communication system (Step 8); and dialing a call from the second wireless communication module 20 and waiting for the receipt of an opposite party (Step 9).

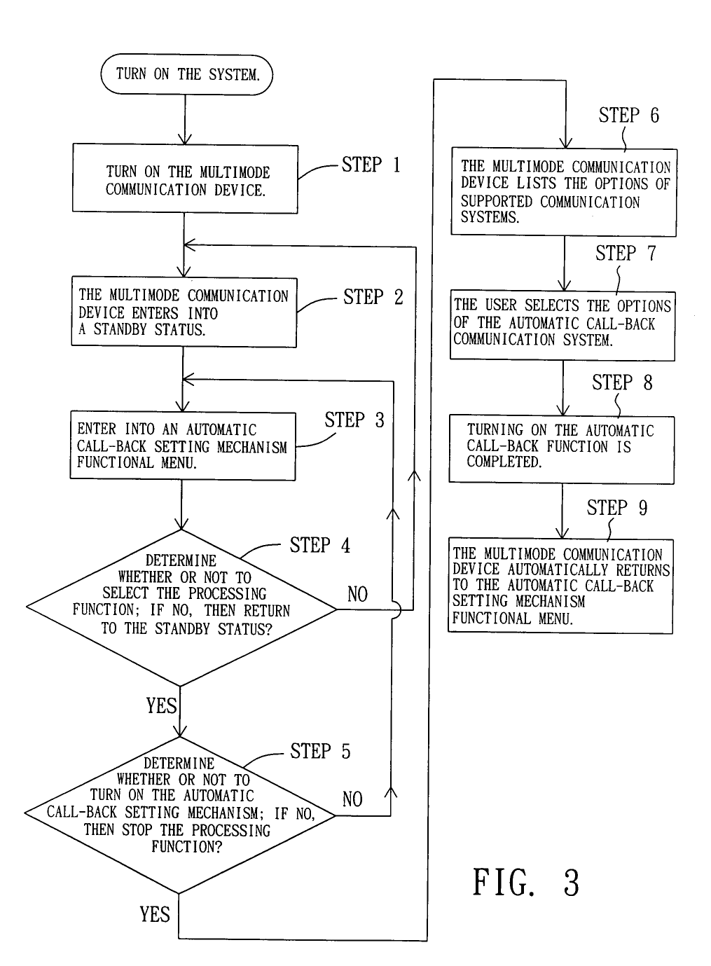

Step 1 determines whether or not the first wireless communication module 10 turns on a call-back communication mechanism, and if no, then the first communication module 10 will ring normally. The call-back communication mechanism is set by a man-machine operating interface controlled by the first wireless communication module 10. Refer to FIG. 3 for a detailed illustration.

Step 2 determines whether or not the incoming call signal of a communication system includes an incoming call number (Caller ID), and if no, then the first wireless communication module 10 will ring normally. If the incoming call signal of the communication system includes an incoming call number (Caller ID), then the second wireless communication module 20 cannot call back, and thus the first wireless communication module 10 will ring normally, and the user can receive that phone call.

Step 3 determines whether or not the incoming call signal comes from a set automatic call-back communication system, and if yes, then the first wireless communication module 10 will ring normally. If the incoming call signal comes from an automatic call-back communication system, it means that a call-back phone call is made, and thus the first wireless communication module 10 rings normally, and the user can receive that call-back phone call.

Step 4 checks a signal and a condition of the second wireless communication module 20, and if the incoming call signal is not from an automatic call-back communication system, then the first wireless communication module 10 can notify the second wireless communication module 20 through the streaming interface 30 to check its signal and condition. For example, the antenna 23 checks the signal intensity of the second wireless communication module and the communication condition of the wireless communication module 20.

Step 5 determines whether or not the signal and condition of the second wireless communication module 20 are good, and if no, then the first wireless communication module 10 will ring normally. If the signal intensity of the second wireless communication module 20 checked by the antenna is not good, or the communication condition of the second wireless communication module 20 is poor, it means that the second wireless communication module 20 cannot call back, and thus the first wireless communication module 10 will ring normally to allow users to receive that phone call.

Step 6 turns on the automatic call-back ring of the first wireless communication module 10. If the signal intensity of the second wireless communication module 20 checked by the antenna is strong enough, or the communication condition of the second wireless communication module 20 is good, it means that the second wireless communication module 20 can call back, and thus the automatic call-back ring of the first wireless communication module 10 will be turned on to notify the user to turn on the call-back mechanism.

Step 7 determines whether or not a user receives an incoming call during the period when the automatic call-back ring is turned on, and if yes, then the first wireless communication module 10 receives the incoming call signal normally. If the receiver receives the incoming call during the period when the automatic call-back ring is turned on, it means that the user does not want to call that incoming call signal back, and thus the first wireless communication module 10 will ring normally to allow the user to receive that phone call.

Step 8 hangs up the incoming call signal of the set automatic call-back communication system and turns on the call-back mechanism.

Step 9 dials a call from the second wireless communication module 20 and waits for the receipt of an opposite party. After the opposite party receives the call, the mobile phone user will communicate with the opposite party by the second wireless communication module with a lower rate of telephone fees, and thus the telephone fee can be reduced.

Referring to FIG. 3 for the flow chart of a man-machine operating interface automatically setting a call-back mechanism according to the present invention, the man-machine operating interface of the invention is executed by a multimode communication device. The multimode communication device comprises a first wireless communication module 10 and a second communication module 20, wherein the first communication module 10 is preferably a GSM module and the second communication module 20 is preferable a PHS module. The method of setting the man-machine operating interface comprises the steps of: turning on the multimode communication device (Step 1); the multimode communication device entering into a standby status (Step 2); entering into an automatic call-back setting mechanism functional menu (Step 3); determining whether or not to select a processing function, and if no, then returning to the standby status (Step 4); determining whether or not to turn on the automatic call-back setting mechanism; if no, then stopping the processing function (Step 5); the multimode communication module listing the options supported by the communication system (Step 6); a user selecting the options of the automatic call-back setting mechanism (Step 7); completing the turning on of the automatic call-back setting function (Step 8); and the multimode communication device automatically returning to the automatic call-back setting mechanism functional menu (Step 9).

In Steps 1 and 2, the user turns on the power ON switch (not shown in the figure) of the multimode communication device, so that the multimode communication device enters into a standby status.

In Step 3, the multimode communication device enters into an automatic call-back setting mechanism functional menu after the multimode communication device is turned on or the automatic call-back setting mechanism functional menu is turned on by a special button (not shown in the figure).

In Step 4, the first wireless communication module 10 can determine whether or not the user selects a processing function, and if no, then return to the standby status, and thus the first wireless communication module 10 will return to the standby status, and if yes, it means that the user wants to turn on the automatic call-back setting mechanism. The procedure will go to Step 5.

In Step 5, the first wireless communication module 10 determines whether or not the user turns on the automatic call-back setting mechanism; if no, then stop the processing function and return to the automatic call-back setting mechanism functional menu.

In Step 6, the multimode communication device lists the options supported by the communication system, and the multimode communication device can support the communication systems including GSM, PHS, GPRS, EDGE, and WCDMA for the user's choice.

In Step 7, the user can list the options of the automatic call-back setting mechanism in the GSM, PHS, GPRS, EDGE, and WCDMA communication systems. However, this step should work with the second wireless communication module 20, and thus this step can select the PHS system as the automatic call-back setting mechanism.

In Steps 8 and 9, the automatic call-back function is turned on and the multimode communication device will automatically return to the automatic call-back setting mechanism functional menu.

Therefore, the implementation of the invention can support a multimode communication device having an automatic call-back setting mechanism of two or more mobile phone wireless communication system and its method, so that when a user receives an incoming call at a dual mode mobile phone, the dual mode mobile phone will select the wireless communication system with a lower rate of telephone fees for the communication, and thus achieving the objectives of saving telephone fees and overcoming the foregoing shortcomings of the prior arts.

While the invention has been described by means of specific embodiments, numerous modifications and variations could be made thereto by those skilled in the art without departing from the scope and spirit of the invention set forth in the claims.

In summation of the above description, the present invention herein enhances the performance than the conventional structure and further complies with the patent application requirements and is submitted to the Patent and Trademark Office for review and granting of the commensurate patent rights.

What is claimed is:

1. A multimode communication device having an automatic call-back setting mechanism, comprising:
a first wireless communication module with a determination process for transmitting a first radio frequency signal; and
a second wireless communication module, which is coupled to said first wireless communication module, for transmitting a second radio frequency signal;
thereby if said first wireless communication module receives an incoming call signal from a communication system, said determination process will determine whether or not to terminate said incoming call signal and call back said communication system by said second wireless communication module.

2. The multimode communication device having an automatic call-back setting mechanism of claim 1, wherein said first wireless communication module is a GSM communication module further comprising:
a baseband module for transmitting a baseband signal;
a radio frequency module, which is coupled to said baseband module, for converting said baseband signal into said first radio frequency signal; and
an antenna, which is coupled to said radio frequency module, for transmitting or receiving said first radio frequency signal.

3. The multimode communication device having an automatic call-back setting mechanism of claim 2, wherein said baseband module further comprises:
a primary central processor for executing said determination process; and
a memory, which is coupled to said primary central processing unit, for storing said determination process and temporarily saving data.

4. The multimode communication device having an automatic call-back setting mechanism of claim 2, wherein said radio frequency module is a GSM radio frequency module, and said first radio frequency signal is a GSM radio frequency signal.

5. The multimode communication device having an automatic call-back setting mechanism of claim 1, wherein said second wireless communication module is a PHS communication module comprising:
a baseband module for transmitting a baseband signal;
a radio frequency module, which is coupled to said baseband module, for converting said baseband signal into said second radio frequency signal; and
an antenna, which is coupled to said radio frequency module, for transmitting or receiving said second radio frequency signal.

6. The multimode communication device having an automatic call-back setting mechanism of claim 5, wherein said baseband module further comprises:
a secondary central processor for assisting said primary central process to execute said determination process; and
a memory, which is coupled to said secondary central processor, for temporarily saving data.

7. The multimode communication device having an automatic call-back setting mechanism of claim 1, wherein said first wireless communication module is coupled to said second wireless communication module by a streaming interface.

8. The multimode communication device having an automatic call-back setting mechanism of claim 5, wherein said radio frequency module is a PHS radio frequency module, and said second radio frequency signal is a PHS radio frequency signal.

9. The multimode communication device having an automatic call-back setting mechanism of claim 1, wherein said determination process comprises the steps of:
determining whether or not said first wireless communication module turns on a call-back communication mechanism, and if no, then said first communication module will ring normally;
determining whether or not said incoming call signal of a communication system includes an incoming call number, and if no, then said first wireless communication module will ring normally;
determining whether or not said incoming call signal comes from a set automatic call-back communication system, and if yes, then said first wireless communication module will ring normally;
checking a signal and a condition of said second wireless communication module;
determining whether or not said signal and condition of said second wireless communication module are available, and if no, then said first wireless communication module will ring normally;
turning on the automatic call-back ring of said first wireless communication module;
determining whether or not a user receives an incoming call during the period when said automatic call-back ring is turned on, and if yes, then said first wireless communication module normally receives said incoming call signal;
hanging up said incoming call signal of said set automatic call-back communication system; and
dialing a call from said second wireless communication module and waiting for the receipt of an opposite party.

10. The multimode communication device having an automatic call-back setting mechanism of claim 9, wherein said call-back communication mechanism is set on or off by a man-machine operating interface controlled by said first wireless communication module.

11. The multimode communication device having an automatic call-back setting mechanism of claim 9, wherein said signal and condition of said call-back communication system is the signal intensity of said second wireless communication module.

12. A method for automatically setting a call-back phone call, used in a multimode communication device, and said multimode communication device comprises a first wireless communication module and a second wireless communication module and said method comprising the steps of:
determining whether or not said first wireless communication module turns on a call-back communication mechanism, and if no, then said first communication module will ring normally;
determining whether or not said incoming call signal of a communication system includes an incoming call number, and if no, then said first wireless communication module will ring normally;
determining whether or not said incoming call signal comes from a set automatic call-back communication system, and if yes, then said first wireless communication module will ring normally;
checking a signal and a condition of said second wireless communication module;
determining whether or not said signal and condition of said second wireless communication module are available, and if no, then said first wireless communication module will ring normally;
turning on the automatic call-back ring of said first wireless communication module;
determining whether or not a user receives an incoming call during the period when said automatic call-back ring is turned on, and if yes, then said first wireless communication module normally receives said incoming call signal;
hanging up said incoming call signal of said set automatic call-back communication system; and
dialing a call from said second wireless communication module and waiting for the receipt of an opposite party.

13. The method for automatically setting a call-back phone call of claim 12, wherein said first wireless communication module is a GSM module.

14. The method for automatically setting a call-back phone call of claim 12, wherein said second wireless communication module is a PHS module.

15. The method for automatically setting a call-back phone call of claim 12, wherein said call-back communication mechanism is set on or off by a man-machine operating interface controlled by said first wireless communication module.

16. The method for automatically setting a call-back phone call of claim 12, wherein said signal and condition of said second wireless communication are the signal intensity of said second wireless communication module and the communication condition of said second wireless communication module.

17. A method of setting a man-machine operating interface of an automatic call-back setting mechanism, capable of being executed in a multimode communication device, and said multimode communication device comprising a first wireless communication module and a second wireless communication module, and said method of setting said man-machine interface comprising the steps of:
turning on said multimode communication device;
said multimode communication device entering into a standby status;
entering into an automatic call-back setting mechanism functional menu;
determining whether or not to select a processing function, and if no, then returning to the standby status;
determining whether or not to turn on said automatic call-back setting mechanism;
if no, then stopping said processing function;
said multimode communication module listing the options supported by said communication system;
a user selecting the options of said automatic call-back setting mechanism;
completing the turning on of said automatic call-back setting function; and
said multimode communication device automatically returning to said automatic call-back setting mechanism functional menu.

18. The method of setting a man-machine operating interface of an automatic call-back setting mechanism of claim 17, wherein said first wireless communication module is a GSM module and said second wireless communication module is a PHS module.

19. The method of setting a man-machine operating interface of an automatic call-back setting mechanism of claim 17, wherein said multimode communication device supports a communication system selected from the collection of GSM, PHS, GPRS, EDGE, and WCDMA.

20. The method of setting a man-machine operating interface of an automatic call-back setting mechanism of claim 17, wherein said multimode communication device enters into said automatic call-back setting mechanism functional menu after said multimode communication device is turned on, or a press button is used for turning on said automatic call-back setting mechanism functional menu.
